(19) United States
(12) Patent Application Publication
(10) Pub. No.: US 2022/0041213 A1
(43) Pub. Date: Feb. 10, 2022

(54) KING PIN ASSEMBLY

(71) Applicant: Dana Italia S.r.l., Arco (IT)

(72) Inventors: Carlo ASTE, Rovereto (IT); Fabrizio DENEI, Riva del Garda (IT); Nicola TESSARO, Arco (IT)

(73) Assignee: Dana Italia S.r.l., Arco (IT)

(21) Appl. No.: 17/381,239

(22) Filed: Jul. 21, 2021

(30) Foreign Application Priority Data
Aug. 4, 2020 (DE) 20 2020 104 506.7

(51) Int. Cl. B62D 7/18; F16C 19/54; F16C 25/08

(52) U.S. Cl. CPC B62D 7/18; F16C 2326/24; F16C 25/08; F16C 19/54

(57) ABSTRACT

A king pin assembly for rotatably connecting a steering knuckle with an axle member may have a first king pin. The assembly may also have a first member with a first recess for receiving the first king pin. The first member may have a steering knuckle or an axle member. A portion of the first member that may enclose the first recess may have a female thread. The first king pin may have a male thread engaged with or configured to be engaged with the female thread enclosing the first recess.

### FIELD

The present document relates to a king pin assembly, in particular for rotatably connecting a steering knuckle with an axle member. King pin assemblies of the presently proposed type may find application in vehicles, for example in heavy-duty vehicles such as agricultural vehicles, wheel loaders, wheeled excavators, heavy trucks, or the like.

### BACKGROUND

Steering mechanisms for vehicles, for example for heavy-duty vehicles such as heavy trucks, are commonly realized by means of one or more king pins. Typically, a king pin is an elongate member made of metal such as steel and provides a rotatable connection between two components. A bearing for reducing wear is commonly provided between the king pin and the component on which the king pin is rotatably mounted. Advantageously, the king pin preload may be adjusted in order to prevent excessive free play and the risk of brinelling or stiff steering.

For example, the preload of the bearing receiving the king pin may be adjusted by placing shims between the bearing and the steering knuckle or the axle member during assembly. In this case, the preload of the bearing receiving the king pin correlates with the height of the shims. However, the shimming process is a trial and error process which is often time consuming and imprecise.

Another approach for adjusting the preload of a king pin in a steering knuckle is known from reference US 2004/0227319 A1. This assembly includes a single tapered roller bearing mounted on a lower yoke arm and a needle bearing mounted on an upper yoke arm of the steering knuckle, while a king pin is disposed in between both of said bearings. A spring cap disposed on the upper yoke arm acts on the top boss of the king pin for preloading the tapered roller bearing mounted on the lower yoke arm.

A common disadvantage of known king pin assemblies is that the king pin preload cannot be adjusted easily without disassembling the joint.

Thus, there is a demand for a king pin assembly in which the king pin preload may be adjusted quickly and easily.

### SUMMARY

This object is solved by a king pin assembly including the features of the claims claim 1.

Special embodiments are described in the dependent claims.

The presently proposed king pin assembly comprises a first king pin and a first member comprising or forming a first recess for receiving the first king pin, the first member comprising or being configured as a steering knuckle or an axle member, wherein a portion of the first member enclosing the first recess includes a female thread or female screw thread. The female thread enclosing the first recess may be directly machined into the portion of the first member enclosing or delimiting the first recess. In other words, the female thread enclosing the first recess and the first member are preferably formed in one piece. The first king pin comprises a male thread or male screw thread engaged with or configured to be engaged with the female thread enclosing the first recess. The male thread of the first king pin is usually formed in an outer surface of the first king pin. Preferably, the first king pin and the male thread of the first king pin are made in one piece. In this way, a position of the first king pin with respect to the first member is adjustable by moving the male thread of the first king pin along the female thread enclosing the first recess. This allows setting or adjusting a preload on the first king pin quickly and easily. For example, the preload on the first king pin may usually be selectively increased or decreased by moving or rotating the male thread of the first king pin along different directions along the female thread enclosing the first recess. The king pin and the first member may be made of or at least partially made of metal such as steel.

The king pin assembly may further comprise a fastening or locking member for fixing, fastening or locking the first king pin in or with respect to the first member when the first king pin is received in the first recess and the female thread enclosing the first recess and the male thread of the first king pin are engaged with one another. For example, the fastening member or locking member may be configured to prevent the first king pin from rotating relative to the first member when the first king pin is received in the first recess. For instance, the fastening member or locking member may comprise a locking screw, a spring based locking mechanism and/or any other known type of releasable retainer.

Additionally, the first member may further comprise or form a bore for receiving the fastening member. The bore may be in communication with the first recess so that when the fastening member is received in the bore, the fastening member is configured to fix or lock the first king pin with respect to the first member when the first king pin is received in the first recess. The first recess may extend in or the female thread enclosing the first recess may define an axial direction, and the bore may extend from the first recess, for example perpendicular to the axial direction.

The bore may further end in an outer surface of the first member. For example, when the fastening member is received in the bore and a first end portion of the fastening member fixes or locks the first king pin with respect to the first member, a second end portion of the fastening member may be accessible via the bore or may protrude out of the bore. This way, the fastening member for fixing or locking the first king pin with respect to the first member may be handled with ease, thereby saving assembly and maintenance time.

Furthermore, a portion of the first member enclosing the bore may include a female thread or female screw thread and the fastening member may have a male thread or male screw thread engaged with or configured to be engaged with the female thread enclosing the bore. Thus, the first king pin may be fixed or locked in or with respect to the first member by moving the male thread of the fastening member along the female thread enclosing the bore. An end portion of the fastening member such as the second end portion may comprise or form a structure such as a recess, a trench or a protrusion for engagement with a fastening tool such as a screwdriver.

The first recess may be a through hole. An end portion of the first king pin may comprise an increased diameter portion and the first recess may have an increased diameter end section for receiving the increased diameter portion of the first king pin when the first king pin is received in the first recess and the male thread of the first king pin is engaged with the female thread enclosing the first recess. The increased diameter portion may facilitate assembly and the handling of the king pin assembly during maintenance or assembly. For instance, the increased diameter portion of the first king pin may act as a mechanical stop and may be configured to prevent the first king pin from being screwed too far into the first recess, thereby reducing the risk of causing damage to the king pin assembly. When the first member comprises the bore for receiving the fastening member, the bore may be in communication with first recess the increased diameter end section of the first recess. This way, when the increased diameter portion of the first king pin is received in the increased diameter end section of the first recess, a force applied to the first king pin via the fastening member received in the bore for fixing the first king pin with respect to the first member may be applied to the more robust increased diameter portion of the first king pin, thereby reducing material strain and fatigue and increasing safety and longevity of the assembly.

The male thread of the first king pin may extend along both axial halves of the first king pin. Preferably, the male thread of the first king pin may extend over at least 20 percent, or over at least 30 percent of the overall axial length of the first king pin. The female thread enclosing the first recess may have the same axial extension as the male thread of the first king pin, for example.

The first king pin may comprise a lubrication channel extending through the first king pin. The lubrication channel may fluidly connect a bearing for receiving the first king pin or a portion thereof with a lubricant reservoir.

The king pin assembly may further comprise a second member. In one embodiment, the first member may comprise or may be configured as a steering knuckle, and the second member may comprise or may be configured as an axle member such as an axle housing. Alternatively, the first member may comprise or may be configured as an axle member such as an axle housing, and the second member may comprise or may be configured as a steering knuckle. A portion of the first king pin protruding out of the first recess may then rotatably connect the first member with the second member, in particular with respect to a rotation axis or steering axis defined by the first king pin when the first king pin is received in the first recess and when the male thread of the first king pin is engaged with the female thread enclosing the first recess. The second member may be made of or may at least partially be made of metal such as steel.

The second member may comprise or may form a first receiving portion. The first receiving portion may be a blind hole. Within the scope of this document, a blind hole is a hole which does not break through a workpiece such as the steering knuckle or an axle member. The portion of the first king pin protruding out of the first recess may be rotatably mounted in the first receiving portion of the second member, for example by means of a first bearing. The first bearing may comprise a roller bearing or an angular contact spherical plain bearing, for example.

The king pin assembly may further comprise a second king pin coaxial with the first king pin with respect to the rotation axis or steering axis. The second king pin may rotatably connect the first member with the second member, for example by means of a second bearing. The second king pin may be made of or may at least partially be made of metal such as steel. The second bearing may comprise a roller bearing or an angular contact spherical plain bearing, for example. For example, the use of two short king pins may require less material than a single long king pin, thereby reducing material and production costs. Further, in some embodiments the two king pins may be arranged only between the first and second member, thereby allowing a clearance to be left between the first king pin and the second king pin along the rotation axis.

The second member may further comprise a second receiving portion coaxial with the first receiving portion with respect to the rotation axis. The second king pin may be rotatably mounted in the second receiving portion of the second member, for example by means of the second bearing. However, it is likewise conceivable that the second king pin is fixedly mounted on the second member and that the second receiving portion in which the second king pin is rotatably received is formed in or by the first member.

When the second member comprises or forms both the first receiving portion and the second receiving portion and both the first receiving portion and the second receiving portion are configured as blind holes, the first receiving portion and the second receiving portion may face in opposite directions along the rotation axis. For example, the first receiving portion and the second receiving portion formed in or by the second member may face away from one another along the rotation axis or steering axis. For example, the first receiving portion may face upward and the second receiving portion may face downward along the rotation axis.

In some embodiments, the first member may comprise a second recess for receiving the second king pin and a portion of the first member enclosing the second recess may include a female thread or female screw thread. The second king pin may comprise a male thread or male screw thread engaged with or configured to be engaged with the female thread enclosing the second recess. In this way, a position of the second king pin with respect to the first member is adjustable by moving the male thread of the second king pin along the female thread enclosing the second recess, as described above with respect to the threaded connection between the first king pin and the first member.

The first member and the second member may be configured such that they form a clearance in between the first king pin and the second king pin along the rotation axis or steering axis so that a drive shaft or a joint may pass through the clearance.

In some embodiments, the king pin assembly may comprise a vehicle wheel hub and a drive shaft or joint drivingly engaged with the vehicle wheel hub. The steering knuckle may be configured to steer the vehicle wheel hub, and the drive shaft or joint may pass through the clearance formed in between the first king pin and the second king pin along the rotation axis or steering axis.

The steering knuckle may further comprise a first arm portion extending at least partially perpendicular to the rotation axis, a second arm portion extending at least partially perpendicular to the rotation axis, and a connecting portion connecting the first arm portion and the second arm portion. The first king pin may be mounted on the first arm portion, the second king pin may be mounted on the second arm portion, and the axle member may be disposed in between the first arm portion and the second arm portion or the axle member may alternatively enclose the first arm portion and the second arm portion of the steering knuckle along the rotation axis.

The above-mentioned object may also be solved by a method for adjusting a king pin preload, in particular in the above-described king pin assembly. As such, the king pin assembly includes at least a steering knuckle, an axle member and a king pin rotatably connecting the steering knuckle with the axle member.

The method comprise the step of adjusting a position of the king pin relative to a steering knuckle or relative to an axle member such as an axle housing by moving a male thread formed on an outer surface of the king pin along a female thread formed in a portion of the steering knuckle enclosing a recess for receiving the king pin.

### DESCRIPTION OF THE FIGURES

Embodiments of the presently proposed king pin assembly and steps for adjusting a king pin preload are described in the following detailed description and are depicted in the Figures, in which

FIG. 1a shows a sectional view of a king pin assembly for a vehicle of the presently proposed type according to a first embodiment;

FIG. 1b shows a detail of the king pin assembly of FIG. 1a;

FIG. 2a shows a first sectional view of a king pin assembly for a vehicle of the presently proposed type according to a second embodiment;

FIG. 2b shows a second sectional view of the king pin assembly of FIG. 2a; and

FIG. 3 shows steps of a method of adjusting a king pin preload.

The Figures relate to two proposed embodiments of a king pin assembly and to a method of adjusting a king pin preload. The figures are drawn to scale. However, the presently proposed king pin assembly shall not necessarily be limited to the drawn scale and may be realized using other dimensions, in particular other relative dimensions. Furthermore, same features recurring in different figures are designated with the same reference signs.

### DETAILED DESCRIPTION

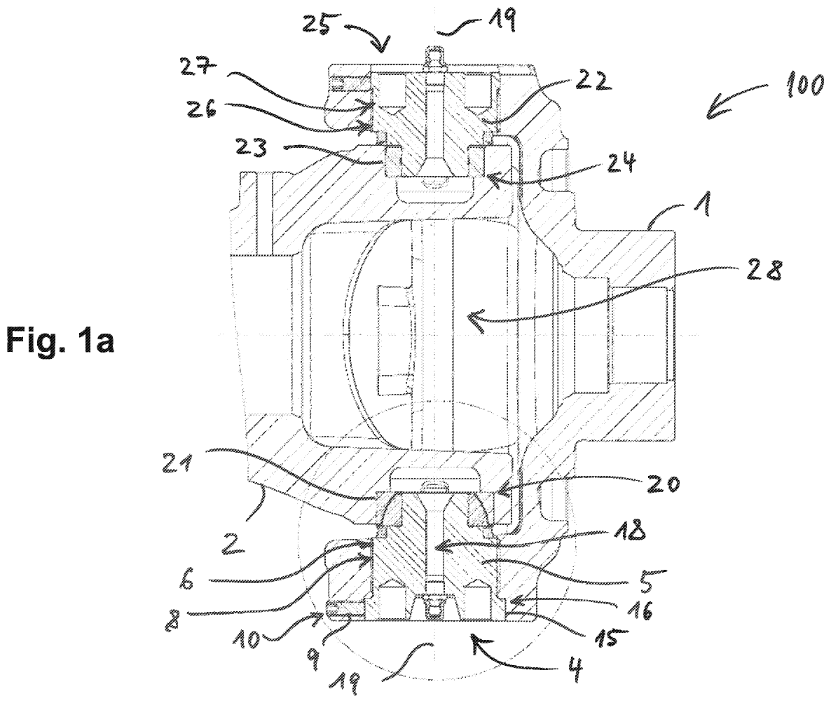

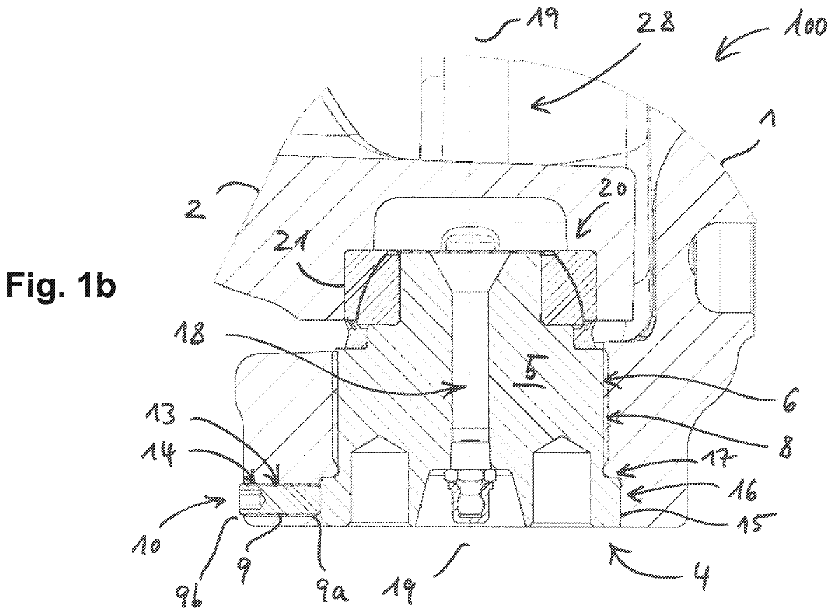

FIGS. 1a shows a sectional view of a king pin assembly 100 of the presently proposed type according to a first embodiment. FIG. 1b depicts a detail of the king pin assembly 100 of FIG. 1a. The king pin assembly 100 comprises a steering knuckle 1, an axle member 2 such as an axle housing, and a first king pin 5. A vehicle wheel (not shown) may be rotatably mounted on the steering knuckle 1. The first king pin 5 may be fixedly received in a first recess 4 of or formed in the steering knuckle 1 and rotatably mounted in a first receiving portion 20 of the axle member 2, thereby providing a rotatable connection between the steering knuckle 1 and the axle member 2. The rotatable connection forms part of a steering assembly of the vehicle.

According to the embodiment shown in FIGS. 1a, 1b, a first bearing 21 may be received in the first receiving portion 20 of the axle member 2. The first bearing 21 may comprise a roller bearing or an angular contact spherical plain bearing, for example. The first king pin 5 and the steering knuckle 1 may be made of metal such as steel, for example. The first bearing 21 facilitates rotation of the steering knuckle 1 relative to the axle member 2 and reduces friction. The functionality of the rotary joint including the first king pin 5 and the first receiving portion 20 may be improved by adjusting the king pin preload. For example, an incorrectly set preload may lead to excessive free play or to a risk of brinelling or stiff steering of the king pin assembly 100.

In order to allow the king pin preload to be adjusted, a portion of the steering knuckle 1 enclosing the first recess 4 includes a female thread or female screw thread 6, and the first king pin 5 includes a male thread or screw thread 8 configured to be engaged with the female thread 6 enclosing the first recess 4. The female thread 6 enclosing the first recess 4 may be directly machined into the portion of the steering knuckle 1 enclosing and delimiting the first recess 4. In other words, the female thread 6 and the steering knuckle 1 may be formed in one piece. Similarly, the male thread 8 of the first king pin 5 may be directly machined into an outer surface of the first king pin 5. In other words, the male thread 8 and the first king pin 5 may be formed in one piece. The male thread 8 of the first king pin 5 may extend over both axial halves of the first king pin 5.

When the female thread 6 enclosing the first recess 4 and the male thread 8 of the first king pin 5 are engaged with each other the first king pin 5 defines a rotation axis or steering axis 19. The steering knuckle 1 may be rotated relative to the axle member 2 with respect to the rotation axis or steering axis 19. By moving the male thread 8 of the first king pin 5 along the female thread 6 enclosing the first recess 4, an axial position of the first king pin 5 with respect to the steering knuckle 1 may be adjusted, thereby adjusting a preload of the first king pin 5 acting on the first receiving portion 20 along the rotation axis 19, and in particular acting on the first bearing 21 in which a portion of the first king pin 5 protruding out of the first recess 4 is rotatably received. The threaded connection between the first king pin 5 and the steering knuckle 1 allows adjusting the preload of the first king pin 5 acting on the first receiving portion 20, and in particular on the first bearing 21, fast, easily and with high precision. In particular, the king pin preload may be adjusted without disassembling.

The king pin assembly 100 may further comprise a fastening member 9 for fixing or locking the first king 5 pin in or with respect to the steering knuckle 1 when the first king pin 5 is received in the first recess 4 and the threads 6, 8 are engaged with one another. The fastening member 9 may be forced or pressed against or frictionally engaged with the first king pin 5, for example, thereby preventing the first king pin 5 from rotating relative to the steering knuckle 1 and fixing the first king pin 5 relative to the steering knuckle 1 along the axial direction 19. As shown in FIGS. 1a, 1b, the fastening member 9 may configured as a locking screw that may be screwed to apply a force for fixing the first king pin 5 relative to the steering knuckle 1. However, the fastening member 9 may also or alternatively comprise a spring based locking mechanism and/or any other known type of releasable retainer capable of fixing the first king pin 5 relative to the steering knuckle 1.

The fastening member 9 may be received in a bore 10 formed in the steering knuckle 1. The bore 10 may be in communication with the first recess 4 formed in the steering knuckle 1. The bore 10 may extend perpendicular to the axial direction 19, thereby allowing the fastening member 9 received in the bore 10 to be forced or pressed against the first king pin 5 at a 90 degree angle or possibly at a smaller angle. Consequently, a fastening member, such as the fastening member 9, may prevent preload losses caused by axial movement of the first king pin 5 relative to the steering knuckle 1. Further-more, the bore 10 and fastening member 9 according to the embodiment of the assembly 100 shown in FIGS. 1a, 1b may contribute to reducing the extension of the assembly 100 along the axial direction 19.

As illustrated in FIGS. 1a, 1b, the first receiving portion 20 may be configured as a blind hole formed in the axle member 2 or in a surface of the axle member 2. In this way, the first receiving portion 20 may be used as a reservoir for supplying lubricant to the first bearing 21. The lubricant reservoir may be connected to an external lubricant reservoir and/or to a greater via a lubrication channel 18 extending through the first king pin 5. Seals may be provided for sealing the first bearing 21.

The king pin assembly 100 may further comprise a second king pin 22 coaxial with the first king pin 5 with respect to the rotation axis or steering axis 19. The second king pin 22 may be made of metal such as steel. The second king pin 22 rotatably connects the steering knuckle 1 with the axle member 2, for example by means of a second bearing 23. The second bearing 23 comprise a roller bearing or an angular contact spherical plain bearing. The second bearing 23 may be arranged in a second receiving portion 24 disposed on or formed in the axle member 2 for receiving the second king pin 22. The second receiving portion 24 may be coaxial with the first receiving portion 20 disposed on or formed in the axle member 2. In the embodiment shown in FIG. 1, the second receiving portion 24 is configured as a blind hole formed in the axle member 2 or in a surface of the axle member 2. The blind holes forming the first receiving portion 21 and the second receiving portion 24 of the axle member 2 may face in opposite directions along the rotation axis or steering axis 19. In particular, the blind holes forming the first receiving portion 21 and the second receiving portion 24 of the axle member 2 may face away from one another along the rotation axis 19. For example, the blind hole forming the, first receiving portion 21 may face upward and the blind hole forming the second receiving portion 24 may face downward along the rotation axis 19. For example, the use of two short king pins 5, 22 aligned coaxially may require less material than a single long king pin, thereby reducing material and production costs. Further, when both king pins 5, 22 are arranged only between the steering knuckle 1 and the axle member, respectively, for example, a clearance 28 may be formed between the first king pin 5 and the second king 22 pin along the rotation axis 19. The clearance 28 may be used to accommodate a drive shaft or a joint which may pass through the clearance 28.

As shown in the first embodiment of FIGS. 1a, 1b, the steering knuckle 1 may further comprise or form a second recess 25 for receiving the second king pin 22, and a portion of the steering knuckle 1 enclosing the second recess 25 may include a female thread 26. The second king pin 22 may comprise a male thread 27 configured to be engaged with the female thread 26 enclosing the second recess 25. In this way, a position of the second king pin 22 with respect to the steering knuckle 1 along the rotation axis 19 may be adjusted by moving the male thread 27 of the second king 22 pin along the female thread 26 enclosing the second recess 25. In the embodiment depicted in FIGS. 1a, 1b, both the first king pin 5 and the second king pin 22 are mounted on or connected to the steering knuckle 1 via a threaded connection. However, it is to be understood that in alternative embodiments only one of the two king pins 5, 22 may be mounted on or connected to the steering knuckle 1 via a threaded connection.

The fastening member 9 comprises two opposite axial ends, a first end portion 9a and a second end portion 9b. The first end portion 9a may be pressed against or engaged with the first king pin 5 to fix the first king pin 5 relative to the steering knuckle 1. The bore 10 may end in an outer surface of the steering knuckle 1 so that the second end portion 9b of the fastening member 9 is accessible via the bore 10 or protrudes out of the bore 10 when the fastening member 9 is received in the bore 10 and the first end portion 9a of the fastening member 9 fixes the first king pin 5 in the first recess 4 with respect to the steering knuckle 1.

Furthermore, a portion of the steering knuckle 1 enclosing the bore 10 may include a female thread or female screw thread 13. The fastening member 9 may have a male thread or male screw thread 14 engaged with or configured to be engaged with the female thread 13 enclosing the bore 10. The female thread 13 enclosing the bore 10 may be directly machined into the portion of the steering knuckle 1 enclosing and delimiting the bore 10. In other words, the female thread 13 and the steering knuckle 1 may be formed in one piece. In order to fix the first king pin 5 in the first recess 4 with respect to the steering knuckle 1 or in order to release the first king pin 5, the male thread 14 of the fastening member 9 may be moved along the female thread 13 enclosing the bore 10. As shown in FIGS. 1a, 1b, the fastening member 9 may include or may be configured as a locking screw. The second end portion 9b of the fastening member 9 may comprise a structure such as a recess, a trench or a protrusion for engagement with a fastening tool such as a screwdriver.

The first recess 4 may be configured as a through hole extending through the steering knuckle 1 or through a portion thereof. In the embodiment depicted in the figures, end portion of the first king pin 5 comprises an increased diameter portion 15, and the first recess 4 has a corresponding increased diameter end section 16 for receiving the increased diameter portion 15 of the first king pin 5 when the first king pin 5 is received in the first recess 4 and the male thread 8 of the first king pin 5 is engaged with the female thread 6 enclosing the first recess 4. The increased diameter end section 16 forms a shoulder 17 in the portion of the steering knuckle 1 delimiting the first recess 4. The shoulder 17 forms a mechanical stop for the increased diameter portion 15 of the first king pin 5. The mechanical stop formed by the shoulder portion prevents the first king pin 5 from being screwed too far into the first recess 4, thereby reducing the risk of causing damage to the king pin assembly 100. In the embodiment depicted in the figures, the bore 10 is in communication with the increased diameter end section 16 of the first recess 4. In this way, a force applied to the first king pin 5 via the fastening member 9 for fixing the first king pin 5 with respect to the steering knuckle 1 may be applied to the more robust increased diameter portion 15 of the first king pin 5, thereby reducing material strain and fatigue and increasing safety and longevity of the assembly 100.

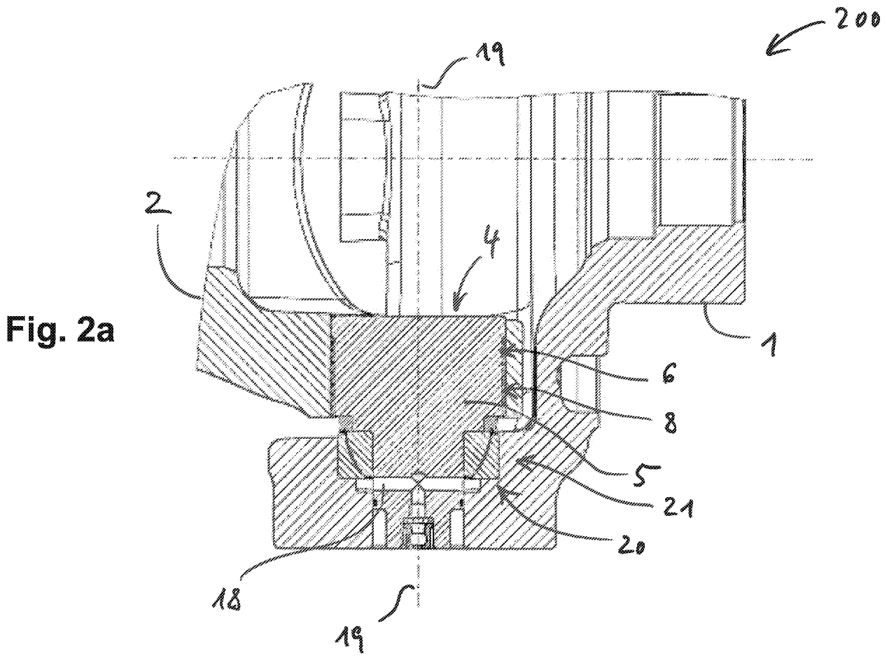

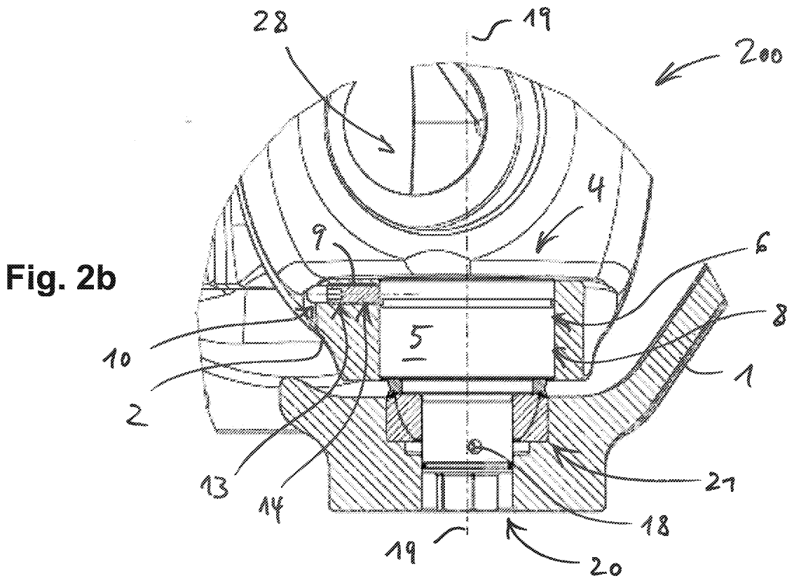

FIGS. 2a, 2b show sectional views of a king pin assembly 200 of the presently proposed type according to a second embodiment. The sectional planes of FIGS. 2a, 2b are arranged perpendicular with respect to each other. The king pin assembly 200 again comprises a steering knuckle 1, an axle member 2 such as an axle housing, and a king pin 5 providing a rotary connection or rotary joint between the steering knuckle 1 and the axle member 2. The king pin 5 defines a rotation axis or steering axis 19, allowing the king pin 5 to rotate relative to the axle member 2 with respect to the rotation axis or steering axis 19.

The king pin assembly 200 of FIGS. 2a, 2b according to the second embodiment differs from the king pin assembly 100 of FIGS. 1a, 1b according to the first embodiment in that in the king pin assembly 200 the king pin 5 is fixedly mounted on the axle member 2 via a threaded connection between the axle member 2 and the king pin 5, and rotatably mounted on the steering knuckle 1.

Specifically, the axle member 2 comprises or forms a recess 4. In the embodiment depicted in FIGS. 2a, 2b the recess 4 is configured as a through hole extending through a portion of the axle member 2. A portion of the axle member 2 enclosing and delimiting the recess 4 includes a female thread or screw thread 6. The thread 6 may be directly machined in the portion of the axle member 2 enclosing and delimiting the recess 4. In other words, the axle member 2 and the female thread 6 enclosing the recess 4 may be formed in one piece. The king pin 5 comprises a corresponding male thread or screw thread 8 formed on an outer surface of the king pin 5. The male thread 8 of the king pin 5 and the female thread 6 enclosing the recess 4 are engaged or configured to be engaged with one another.

A portion of the king pin 5 protruding out of the recess 4 formed in the axle member 2 is received in a receiving portion 20 of the steering knuckle 1. In the embodiment depicted in FIGS. 2a, 2b the receiving portion 20 is configured as a through hole extending through a portion of the steering knuckle 1. A bearing 21 such as a roller bearing, an angular contact spherical plain bearing or the like is received in the receiving portion 20 of the steering knuckle 1 and disposed between the portion of the steering knuckle 1 enclosing the receiving portion 20 and the king pin 5. In other words, the king pin 5 is rotatably mounted in or supported by the bearing 21. The king pin 5 comprises a lubrication channel 18 extending through the king pin 5. When the king pin 5 is received in the receiving portion 20 of the steering knuckle 1, the lubrication channel 18 fluidly connects the bearing 21 with an outside of the king pin assembly 200 so that the bearing 21 may be lubricated via the lubrication channel 18. In the embodiment depicted in FIGS. 2a, 2b the lubrication channel extends in parallel to the rotation axis or steering axis 19 and perpendicular thereto.

A position of the king pin 5 relative to the axle member 2 in the direction of the rotation axis or steering axis 19 may be adjusted by moving the male thread 8 of the king pin 5 along the female thread 6 enclosing the recess 4. In this manner, a king pin preload acting on the steering knuckle 1 and in particular on the bearing 21 mounted on the steering knuckle 1 for receiving the king pin 5 may be set such as for optimizing the functionality of the rotary connection or rotary joint.

Similar to the king pin assembly 100 according to the first embodiment depicted in FIGS. 1a, 1b the king pin assembly 200 according to the second embodiment 200 depicted in FIGS. 2a, 2b further comprises a fastening member or locking member 9 for fixing, fastening or locking the king pin 5 in or with respect to the axle member 2 when the king pin 5 is received in the recess 4 and the threads 6, 8 are engaged with one another. The fastening member 9 is received in a bore 10 which extends through a portion of the axle member 2 and is in communication with the recess 4. The bore 10 ends in an outer surface of the axle member 2. In this manner, the fastening member 9 is accessible via the bore 10 when the fastening member 9 is received within the bore 10. In the embodiment depicted in FIGS. 2a, 2b the bore 10 extends perpendicular to the rotation axis or steering axis 19.

A portion of the axle member 2 enclosing the bore 10 includes a female thread or screw thread 13, and the fastening member 9 includes a corresponding male thread formed on an outer side of the fastening member 9 and configured to be engaged with the female thread 13 enclosing the bore 10. For example, the fastening member 9 may be configured as a locking screw. Thus, the fastening member 9 may be moved or displaced within the bore by moving the male threads 14 of the fastening member 9 along the female thread 13 enclosing the bore 10. In order to fix, fasten or lock the king pin 5 with respect to the axle member 2 when the king pin 5 is received in the recess 4 and the threads 6, 8 are engaged with one another, the fastening member 9 may be forced or pressed against the king pin 5 or engaged with the king pin 5, thereby preventing the king pin 5 from rotating with respect to the axle member 2. To this end, an end portion of the fastening member 9 which is accessible via the bore 10 or which protrudes out of the bore 10 may include a structure such as a recess, a trench or a protrusion for engagement with a fastening tool such as a screwdriver.

In some embodiments, the king pin assemblies 100, 200 may comprise a vehicle wheel hub and a drive shaft or joint drivingly engaged with the vehicle wheel hub. The steering knuckle 1 may be configured to steer the vehicle wheel hub and the drive shaft or joint may pass through the clearance 28. The steering knuckle 1 may further comprise a first arm portion and a second arm portion each extending at least partially perpendicular to the rotation axis 19 defined by the first king pin 5. A connecting portion may connect the first arm portion and the second arm portion (not shown). The first king pin 5 may be mounted on the first arm portion, the second king pin 22 may be mounted on the second arm portion, and the axle member 2 may be disposed in between the first arm portion and the second arm portion or the axle member 2 may alternatively enclose the first arm portion and the second arm portion of the steering knuckle 1 along the rotation axis or steering axis 19.

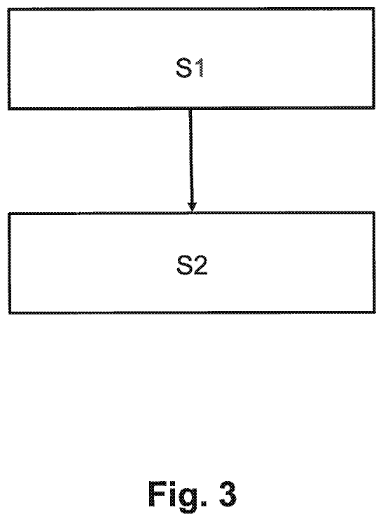

FIG. 3 schematically depicts steps of a method of adjusting a position of the king pin 5 relative to the steering knuckle 1 (see FIGS. 1a, 1b) or relative to the axle member 2 (see FIGS. 2a, 2b). The first step S1 includes moving the male thread 8 of the king pin 5 along the female thread 6 enclosing the recess 4. And the second step 2 includes fastening or locking the king pin 5 relative to the steering knuckle (see FIGS. 1a, 1b) or relative to the axle member 2 (FIGS. 2a, 2b), such as by pressing the fastening member 9 against or engaging the fastening member 9 with the king pin 5 when the king pin 5 is received in the recess 4 and the threads 6, 8 are engaged with one another.

1-18. (canceled)

19. A king pin assembly for rotatably connecting a steering knuckle with an axle member, comprising:
a first king pin, and
a first member comprising a first recess for receiving the first king pin, the first member comprising a steering knuckle or an axle member, wherein a portion of the first member enclosing the first recess includes a female thread,
wherein the first king pin comprises a male thread engaged with or configured to be engaged with the female thread enclosing the first recess.

20. The king pin assembly according to claim 19, further comprising a fastening member for fixing the first king pin with respect to the first member when the first king pin is received in the first recess.

21. The king pin assembly according to claim 20, wherein the first member further comprises a bore for receiving the fastening member, wherein the bore is in communication with the first recess so that when the fastening member is received in the bore, the fastening member is configured to fix or lock the first king pin in the first recess with respect to the first member.

22. The king pin assembly according to claim 21, wherein the bore ends in an outer surface of the first member so that when the fastening member is received in the bore and a first end portion of the fastening member fixes or locks the first king pin with respect to the first member, a second end portion of the fastening member is accessible via the bore or protrudes out of the bore.

23. The king pin assembly according to claim 21, wherein a portion of the first member enclosing the bore includes a female thread and the fastening member has a male thread engaged with or configured to be engaged with the female thread enclosing the bore for fixing or locking the first king pin with respect to the first member by moving the male thread of the fastening member along the female thread enclosing the bore.

24. The king pin assembly according to claim 19, wherein the first recess is a through hole.

25. The king pin assembly according to claim 24, wherein an end portion of the first king pin comprises an increased diameter portion and that the first recess has an increased diameter end section for receiving the increased diameter portion of the first king pin when the first king pin is received in the first recess and the male thread of the first king pin is engaged with the female thread enclosing the first recess.

26. The king pin assembly according to claim 19, wherein the male thread of the first king pin extends along both axial halves of the first king pin.

27. The king pin assembly according to claim 19, wherein the first king pin comprises a lubrication channel extending through the first king pin.

28. The king pin assembly according to claim 19, further comprising a second member, wherein
a. the first member comprises the steering knuckle and the second member comprises the axle member, or
b. the first member comprises the axle member and the second member comprises the steering knuckle,
wherein a portion of the first king pin protruding out of the first recess when the first king pin is received in the first recess and when the male thread of the first king pin is engaged with the female thread enclosing the first recess rotatably connects the first member with the second member.

29. The king pin assembly according to claim 28, wherein the second member comprises a first receiving portion, wherein the portion of the first king pin protruding out of the first recess is rotatably mounted in the first receiving portion of the second member via a first bearing.

30. The king pin assembly according to claim 28, further comprising a second king pin coaxial with the first king pin, the second king pin rotatably connecting the first member with the second member via a second bearing.

31. The king pin assembly according to claim 30, wherein the second member further comprises a second receiving portion coaxial with the first receiving portion with respect to the rotation axis, wherein the second king pin is rotatably mounted in the second receiving portion of the second member via the second bearing.

32. The king pin assembly according to the claim 31, wherein the first receiving portion and the second receiving portion of the second member are configured as blind holes facing in opposite directions along the rotation axis, wherein the first receiving portion and the second receiving portion of the second member face away from one another along the rotation axis.

33. The king pin assembly according to claim 30, wherein the first member comprises a second recess for receiving the second king pin and a portion of the first member enclosing the second recess includes a female thread, wherein the second king pin comprises a male thread engaged with or configured to be engaged with the female thread enclosing the second recess.

34. The king pin assembly according to claim 31, wherein the first member and the second member are configured such that they form a clearance in between the first king pin and the second king pin along the rotation axis so that a drive shaft or a joint may pass through the clearance.

35. The king pin assembly according to claim 34, further comprising a vehicle wheel hub and a drive shaft or a joint drivingly engaged with the vehicle wheel hub, wherein the steering knuckle is configured to steer the vehicle wheel hub and wherein the drive shaft or joint passes through the clearance formed in between the first king pin and the second king pin along the rotation axis.

36. The king pin assembly according to claim 31, wherein the steering knuckle comprises a first arm portion extending at least partially perpendicular to the rotation axis, a second arm portion extending at least partially perpendicular to the rotation axis, and a connecting portion connecting the first arm portion and the second arm portion, wherein the first king pin is mounted on the first arm portion, the second king pin is mounted on the second arm portion, and wherein the axle member is disposed in between the first arm portion and the second arm portion or wherein the axle member encloses the first arm portion and the second arm portion of the steering knuckle along the rotation axis.
